(19) United States
(12) Patent Application Publication
(10) Pub. No.: US 2024/0323707 A1
(43) Pub. Date: Sep. 26, 2024

(54) NETWORK RESILIENCE

(71) Applicant: Nokia Technologies Oy, Espoo (FI)

(72) Inventors: Subramanya CHANDRASHEKAR, Bangalore (IN); Andres ARJONA, Tokyo (JP); Ömer BULAKCI, Munich (DE)

(21) Appl. No.: 18/575,276

(22) PCT Filed: Jun. 15, 2022
(86) PCT No.: PCT/EP2022/066373

§ 371 Date: Dec. 28, 2023

(30) Foreign Application Priority Data
Jun. 30, 2021 (IN) 202111029369

(51) Int. Cl. H04W 16/32; H04W 92/20

(52) U.S. Cl. CPC H04W 16/32; H04W 92/20

(57) ABSTRACT

According to an example aspect of the present invention, there is provided an apparatus configured to perform as a base station central unit control plane node, setup, into an inactive state, a protocol connection with at least one client node, wherein the apparatus does not control or actively serve the said client node while the protocol connection is in the inactive state, synchronize, while the protocol connection is in the inactive state, at least one control plane user equipment context of the base station from a second base station central unit control plane node which controls the at least one client node, and responsive to receiving an instruction from outside the apparatus, switch the protocol connection into an active state and begin controlling the at least one client node. The apparatus may serve user equipments directly or indirectly.

### FIELD

The present disclosure relates to the field of communication network control and management.

### BACKGROUND

Cellular networks comprise a core network and an access network, wherein the access network comprises plural base nodes, which may be referred to as base stations, for example. Core network nodes are tasked with functions relevant to the entire network, such as subscriber data management and interfacing with other networks, while the access network provides wireless connectivity to user equipments.

Base nodes may be distributed base nodes, such that a base node comprises a central unit, CU, and one or more distributed units, DUs. The functions of base node may be distributed between the CU and DU(s), such that overall the system comprising the CU and one of more DU perform as a base node.

### SUMMARY

According to some aspects, there is provided the subject-matter of the independent claims. Some embodiments are defined in the dependent claims. The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to a first aspect of the present disclosure, there is provided an apparatus comprising at least one processing core, at least one memory including computer program code, the at least one memory and the computer program code being configured to, with the at least one processing core, cause the apparatus at least to perform as a base station central unit control plane node, setup, into an inactive state, a protocol connection with at least one client node, wherein the apparatus does not control or actively serve the said client node while the protocol connection is in the inactive state, synchronize, while the protocol connection is in the inactive state, at least one control plane user equipment context of the base station from a second base station central unit control plane node which controls the at least one client node, and responsive to receiving an instruction from outside the apparatus, switch the protocol connection into an active state and begin controlling the at least one client node.

According to a second aspect of the present disclosure, there is provided an apparatus comprising at least one processing core, at least one memory including computer program code, the at least one memory and the computer program code being configured to, with the at least one processing core, cause the apparatus at least to perform as a base station central unit control plane node, setup, into an active state, a protocol connection with at least one client node, wherein the apparatus controls and serves the at least one client node while the respective protocol connection is in the active state, signal to the at least said one client node to trigger the at least one said client node to setup a respective second protocol connection with a peer node of the base station central unit control plane node by providing configuration information, the second protocol connection to be setup into an inactive state, wherein the peer node does not control the respective client node while the respective second protocol connection is in the inactive state, and synchronize control data of the base station from the base station central unit control plane node to the peer node.

According to a third aspect of the present disclosure, there is provided an apparatus comprising at least one processing core, at least one memory including computer program code, the at least one memory and the computer program code being configured to, with the at least one processing core, cause the apparatus at least to perform as a client node, participate in setting up, into an active state, a first protocol connection with a first base station central unit control plane node, wherein the first base station central unit control plane node controls the apparatus while the first protocol connection is in the active state, participate in setting up, into an inactive state, a second protocol connection with a second base station central unit control plane node, wherein the second base station central unit control plane node does not control the apparatus while the second protocol connection is in the inactive state, and maintain the second protocol connection in the inactive state while the first base station central unit control plane node controls the apparatus over the first protocol connection.

According to a fourth aspect of the present disclosure, there is provided an apparatus comprising at least one processing core, at least one memory including computer program code, the at least one memory and the computer program code being configured to, with the at least one processing core, cause the apparatus at least to determine that a first base station central unit control plane node, tasked with controlling a base station distributed unit, has developed a failure, and responsive to the determination of the failure, signal to a second base station central unit control plane node, which is a stand-by to the first base station central unit control plane node, to trigger the a second base station central unit control plane node to switch its protocol connection with at least the one client node from an inactive state to an active state, to enable the second base station central unit control plane node to control and serve the at least one client node.

According to a fifth aspect of the present disclosure, there is provided a method, comprising performing, by an apparatus, as a base station central unit control plane node, setting up, into an inactive state, a protocol connection with at least one client node, wherein the apparatus does not control or actively serve the at least one client node while the protocol connection is in the inactive state, synchronizing, while the protocol connection is in the inactive state, control plane user equipment contexts of the base station from a second base station central unit control plane node which controls the at least one client node, and responsive to receiving an instruction from outside the apparatus, switching the protocol connection into an active state and beginning controlling the at least one client node.

According to a sixth aspect of the present disclosure, there is provided a method, comprising performing, by an apparatus, as a base station central unit control plane node, setting up, into an active state, a protocol connection with at least one client node, wherein the apparatus controls and serves the at least one client node while the respective protocol connection is in the active state, signalling to the at least one client node to trigger the at least one client node to setup a respective second protocol connection with a peer node of the base station central unit control plane node by providing configuration information, the second protocol connection to be setup into an inactive state, wherein the peer node does not control the respective client node while the respective second protocol connection is in the inactive state, and synchronizing, control data of the base station from the base station central unit control plane node to the peer node.

According to a seventh aspect of the present disclosure, there is provided a method comprising performing, by an apparatus, as a client node, participating in setting up, into an active state, a first protocol connection with a first base station central unit control plane node, wherein the first base station central unit control plane node controls the apparatus while the first protocol connection is in the active state, participating in setting up, into an inactive state, a second protocol connection with a second base station central unit control plane node, wherein the second base station central unit control plane node does not control the apparatus while the second protocol connection is in the inactive state, and maintaining the second protocol connection in the inactive state while the first base station central unit control plane node controls the apparatus over the first protocol connection.

According to an eighth aspect of the present disclosure, there is provided a method comprising performing, by an apparatus, as a client node, participating in setting up, into an active state, a first protocol connection with a first base station central unit control plane node, wherein the first base station central unit control plane node controls the apparatus while the first protocol connection is in the active state, participating in setting up, into an inactive state, a second protocol connection with a second base station central unit control plane node, wherein the second base station central unit control plane node does not control the apparatus while the second protocol connection is in the inactive state, and maintaining the second protocol connection in the inactive state while the first base station central unit control plane node controls the apparatus over the first protocol connection.

According to a ninth aspect of the present disclosure, there is provided a non-transitory computer readable medium having stored thereon a set of computer readable instructions that, when executed by at least one processor, cause an apparatus to at least perform as a base station central unit control plane node, setup, into an inactive state, a protocol connection with at least one client node, wherein the apparatus does not control or actively serve the at least one client node while the protocol connection is in the inactive stat, synchronize, while the protocol connection is in the inactive state, control plane user equipment contexts of the base station from a second base station central unit control plane node which controls the at least one client node, and responsive to an receiving an instruction from outside the apparatus, switch the protocol connection into an active state and begin controlling the at least one client node.

According to a tenth aspect of the present disclosure, there is provided a non-transitory computer readable medium having stored thereon a set of computer readable instructions that, when executed by at least one processor, cause an apparatus to at least perform as a base station central unit control plane node, setup, into an active state, a protocol connection with at least one client node, wherein the apparatus controls and serves the at least one client node while the respective protocol connection is in the active state, and signal to the at least one client node to trigger the at least one client node to setup a respective second protocol connection with a peer node of the base station central unit control plane node, the second protocol connection to be setup into an inactive state, wherein the peer node does not control the at least one client node while the second protocol connection is in the inactive state, and synchronize control data of the base station from the apparatus to the peer node.

According to an eleventh aspect of the present disclosure, there is provided a non-transitory computer readable medium having stored thereon a set of computer readable instructions that, when executed by at least one processor, cause an apparatus to at least perform as a client node, participate in setting up, into an active state, a first protocol connection with a first base station central unit control plane node, wherein the first base station central unit control plane node controls the apparatus while the first protocol connection is in the active state, participate in setting up, into an inactive state, a second protocol connection with a second base station central unit control plane node, wherein the second base station central unit control plane node does not control the apparatus while the second protocol connection is in the inactive state, and maintain the second protocol connection in the inactive state while the first base station central unit control plane node controls the apparatus over the first protocol connection.

According to a twelfth aspect of the present disclosure, there is provided a non-transitory computer readable medium having stored thereon a set of computer readable instructions that, when executed by at least one processor, cause an apparatus to at least determine that a first base station central unit control plane node, tasked with controlling a base station distributed unit, has developed a failure, and responsive to the determination of the failure, signal to a second base station central unit control plane node, which is a stand-by to the first base station central unit control plane node, to trigger the a second base station central unit control plane node to switch its protocol connection with at least one client node from an inactive state to an active state, to enable the second base station central unit control plane node to control and serve the least one client node.

According to a thirteenth aspect of the present disclosure, there is provided a computer program configured to cause a method in accordance with at least one of the fifth, sixth, seventh and eighth aspects to be performed, when run.

### BRIEF DESCRIPTION OF THE DRAWINGS

FIG. 1 illustrates an example system in accordance with at least some embodiments of the present invention;

FIG. 2A illustrates an example service-based radio access network embodiment;

FIG. 2B illustrates an example service-based radio access network embodiment;

FIG. 3 illustrates an example apparatus capable of supporting at least some embodiments of the present invention;

FIG. 4 illustrates signalling in accordance with at least some embodiments of the present invention;

FIG. 5 is a flow graph of a method in accordance with at least some embodiments of the present invention, and

FIG. 6 is a flow graph of a method in accordance with at least some embodiments of the present invention.

### EMBODIMENTS

In a distributed base node architecture, also known as disaggregated base node architecture, resiliency of the central base node unit layer, also referred to as central unit, is enhanced by pre-providing distributed units, and/or other client nodes, with protocol connections, such as interfaces, to one or more backup central unit in an inactive state, such that these protocol connections may be activated from the inactive state to an active state as a response to a failure state of a central unit controlling the distributed units and/or other client nodes. Thus the client node(s) may be provided with a single active connection to a central unit, and data needed to serve user equipments, UEs, connected via the client node may be mirrored to a backup central unit to which the inactive protocol connection connected to.

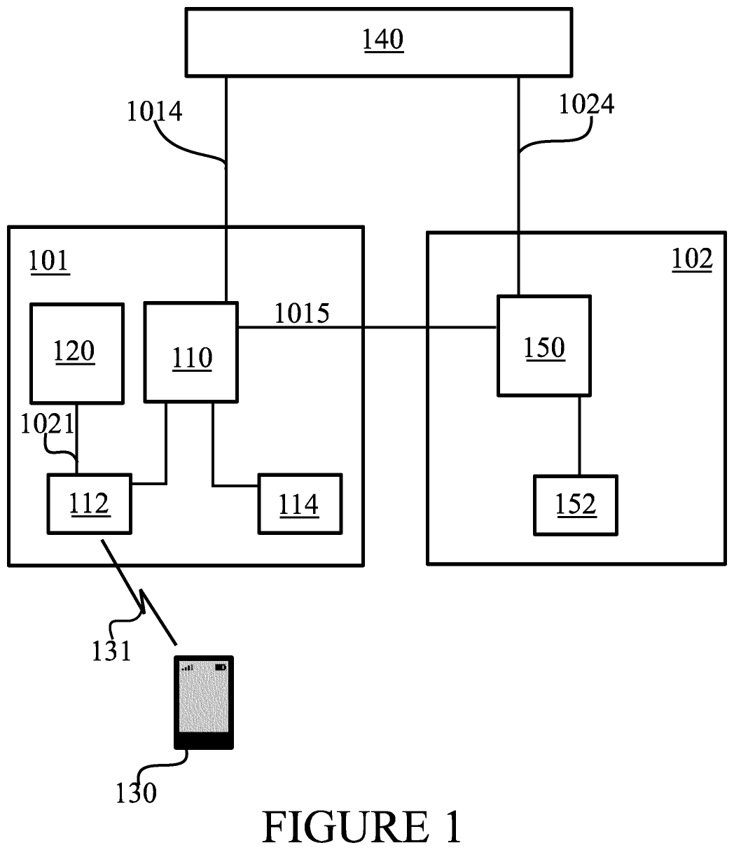

FIG. 1 illustrates an example system in accordance with at least some embodiments of the present invention. Base stations 101 and 102 are connected to core network 140 via respective interfaces 1014 and 1024. In a third generation partnership project, 3GPP, implementation these interfaces may be known as NG interfaces, which are logical interfaces. UE 130 is connected with base station 101 via wireless interface 131. Wireless interface 131 may comprise an uplink and a downlink. The expression “base station” has been adopted for used herein as a terminological choice by which it is not meant to exclude technologies where similar nodes are known as base nodes or access points, for example.

In particular, base stations 101 and 102 are distributed base stations comprising a central unit and one or more distributed units. The central unit may be housed in a distinct physical device which does not house a distributed unit. Base station 101 comprises central unit 110 and distributed units 112 and 114. Base station 102 comprises central unit 150 and distributed unit 152. The central units may be housed in a distinct physical device which does not house a distributed unit. The central units and distributed units together perform the functions of a base station and their distributed nature provides opportunities to install the base stations in a flexible and efficient manner. In particular, distributed units 112, 114, 152 may have radio parts, which the central units 110, 150 do not need. On the other hand, central units 110, 150 control interfacing toward core network 140, for example, which the distributed units 112, 114, 152 consequently do not need to be configured for. Central unit 110 is connected with each of distributed units 112, 114 with a respective interface, which is an F1 interface in a 3GPP implementation and central unit 150 is connected with each of distributed unit 152 with an interface, such as an F1 interface. The shown entities may comprise logical network functions (NFs), such as virtual network functions (VNFs) and/or containerized network functions (CNFs). Accordingly, the shown entities may be physically deployed in different environments, e.g., different cloud environments. For example, the central unit 110 may be implemented/deployed in an edge cloud, while the distributed unit 112 may be implemented/deployed in a far edge cloud. These shown entities may also comprise physical network functions (PNFs).

Data is carried over a user plane (UP) and a control plane (CP). The user plane carries user data through an access stratum using a packet data unit session, while the control plane is tasked with controlling protocol data unit (PDU) sessions and controlling the connection between the UE and the network. Controlling the connection between the UE and the network may comprise control of transmission resources, service requests and handovers, for example.

A base station central unit control plane node, CU-CP, is a logical node which manages aspects of the control plane, such as hosting of radio resource control, RRC, layer and the control plane part of packet data convergence protocol, PDCP. The CU-CP terminates, in a 3GPP implementation, a, F1-C interface toward the distributed unit(s) of the base station. The CU-CP is part of the central unit 110, 150. The central unit further comprises a base station central unit user plane node CU-UP, which is tasked with hosting the user plane part of the PDCP protocol and terminating an F1-U interface toward the distributed unit(s) of the base station. The F1 interface thus comprises a control plane part F1-C and a user plane part F1-U. An E1 interface is arranged between CU-UP and CU-CP in a 3GPP implementation.

In the system of FIG. 1, an Xn interface 1015 is arranged between central units 110 and 150. This interface enables coordination of actions between base stations 101 and 102, for example handover processes where UEs transition from radio attachment to a distributed unit of one of these base stations to a distributed unit of the other one. In particular, a control plane Xn-C interface connects CU-CP of base station 101, in central unit 110, with a CU-CP of base station 102, in central unit 120. Further in FIG. 1, F1 interface 1021 is arranged between distributed unit 112 of base station 101 and a stand-by central unit 120 of base station 101. The stand-by central unit 120 may comprise a complete central unit, or only a stand-by CU-CP. Central unit 120 is comprised in base station 101. As described before, the stand-by central unit 120 may be implemented/deployed in a different environment than the central unit 110.

In case central unit 110 develops a failure while UE 130 is connected through distributed unit 112, protocol connections the UE may time out before connectivity may be successfully re-established. This would result in an interrupted connection and poor user experience. Furthermore, as UE 130 may be a machine-type device, such as connected car connectivity module, an interruption in its connectivity may have an impact even on public safety.

To assist in rapid continuation of connectivity to UEs connected via distributed units of base station 101, distributed units thereof may be provided with backup central unit nodes. While the present disclosure is laid out around distributed unit 112, the principles disclosed herein may be applied equally to other distributed units as well. In particular, distributed unit, DU, 112 is provided with backup F1 interface 1021 with a backup central unit, CU, 120. To maintain connectivity in case of CU-CP failure, DU 112 is instructed by CU-CP of CU 120 to begin accepting control from the CU-CP of CU 120. As the interface 1021 is already in existence, a technical effect is achieved as delays are reduced as the interface need not be established using signalling processes as a response to the failure of CU 110. To further reduce delays, during normal operation the CU-CP of CU 110 may synchronize at least some, and in some embodiments all, of its control data with the CU-CP of CU 120. In addition to a backup F1 interface, also E1, NG, X2 and/or Xn interfaces may be started as backups, so that they need not be established from scratch upon switchover. In some cases, the switchover may take place even in the absence of an active protocol connection.

Backup F1 interface 1021 may comprise the F1 interface as a protocol connection, or, alternatively, more than one protocol connection may be established into an inactive state to wait for switchover to the backup CU-CP. For example, an SCTP connection may be started into an inactive state along with the F1 interface on each application protocol interface used by the CU-CP controlling DU 112. This, along with the data from the controlling CU-CP, ensures that the stand-by CU-CP is ready and available with data synchronized from the active CU-CP, all the time. In some embodiments, the stand-by CU-CP indicates to all its peer entities connected via interfaces when the switchover is performed. This indication may be usable in the peer entities for load balancing, for example. To provide this indication, a new optional information element may be included to a CONFIGURATION UPDATE message, such as F1AP: gNB-CU Configuration Update, for example, to indicate this to the peer entity. In at least some embodiments, whenever the DU finds addition of a new inactive SCTP association over an active F1 connection, the DU triggers a new F1 setup, duplicate of the active one, on the inactive SCTP association. This may involve including an information element to indicate that it is an inactive interface.

When the protocol connection(s) are set up for the back-up CU-CP, these protocol connections may be established into an inactive state. The inactive state may be requested in a respective establishment request message, for example. In the inactive state the protocol connection may be merely kept open with keep-alive packets, for example, with no payload data carried over the protocol connection. In some cases, the protocol connections may be established into one another such that one protocol connection is used to establish another protocol connection, forming an overall multi-layer protocol connection all layers of which are established into an inactive state. Thus, the overall protocol connection between the DU and the backup CU-CP is ready to start controlling the DU in case switchover is needed. CU 110 and CU 120 may be physically distinct devices.

The failure of CU-CP of CU 110 may be detected by CU 120, a DU or by core network 140, for example. Failure detection may be performed by any client of the failed CU-CP or by stream control transmission protocol, SCTP, based mechanisms, for example. A failure of the CU-CP may be reported to the core network by a DU or a neighbouring base station, for example, in case the CU-CP fails to respond to messages. A failure of the CU-CP may also be reported to a network management system, e.g., an OAM system, or a control entity, e.g., near-real time RAN intelligent controller (RIC). If DU 112 detects the failure of CU-CP of CU 110, it may report it to the core network and/or CU 120. DU 112 may signal this to CU 120 using the backup F1 interface 1021, for example. The DU 112 may be provided with an internet protocol, IP, address of the backup CU-CP of CU 120 in connection with initializing the DU 112. The backup CU-CP address may likewise be provided to other nodes which collaborate with CU 110 to enable these nodes to inform the backup CU-CP of the failure as soon as it is reliably detected.

In some embodiments, a node tasked with deciding on detecting failure of a CU-CP receives failure reports concerning a specific CU-CP from one or more entities before determining that the CU-CP has developed a failure. The node may have a threshold defined in terms of a number of failure messages, or failure messages from certain pre-defined entities or entity types may be given more weight in determining the failure. For example, the node may decide that a specific CU-CP has failed responsive to at least half of its DUs reporting such a failure, and/or responsive to a single core network node reporting such a failure. In some embodiments, the node may further ping the CU-CP before deciding it has failed. In case the CU-CP responds to the ping, the node may determine that it has not failed and the error report(s) the node has received are spurious. Avoiding responding to spurious error reports is beneficial, as switching over to a backup CU-CP involves signalling in the network, and the backup CU-CP will become more heavily loaded.

Alternatively or additionally, artificial intelligence or machine learning methods could be used to verify if the detected failure is genuine or not. As an example, an artificial intelligence or machine learning algorithm may compare ongoing traffic with stored traffic information reflective of error-free normal operation. Any mismatches detected can indicate potential issues that may indicate a failure in the CU-CP. Deterministic traffic, such as industrial internet of things time-sensitive network data packets/bursts arriving at pre-determined transfer intervals, can increase the likelihood of correct failure detection decisions as such traffic is dependably comparable to earlier traffic.

In some embodiments, nodes interacting with CU 110, for example DU 112, may report to backup CU 120 that CU 110 has possibly developed a failure, before reporting to a node tasked with deciding on detecting failure of CU 110 that CU 110 has failed. Thus, CU 120 may take actions in anticipation of a possible CU 110 CU-CP failure, such as load reduction or resource management of the CU-CP of CU 120 to prepare to take over traffic of CU 112.

The control data of CU-CP of CU 110 that is synchronized with backup CU-CP of CU 120 may comprise UE contexts of UEs connected through DU 112. This provides the advantage, that the contexts need not be copied or fetched from other nodes in case the backup CU-CP needs to take over. A UE context may comprise one, more than one or all of the following: user equipment state information, security information, user equipment capability information and identities of the user equipment-associated logical NG-connection. The UE context of a specific UE may be copied over to the backup CU-CP at each state change of the UE, for example. The level of synchronization may be per-UE transaction-level or per-UE stable state level and may be configurable by the network operator. Additionally or alternatively, all static information procured over different application protocol interfaces serving the UE may be copied from the active CU-CP to the backup CU-CP during normal operation. Copying such data facilitates seamless take-over by the standby CU-CP in case of failure at the original CU-CP. This, too, reduces delays in the switchover process.

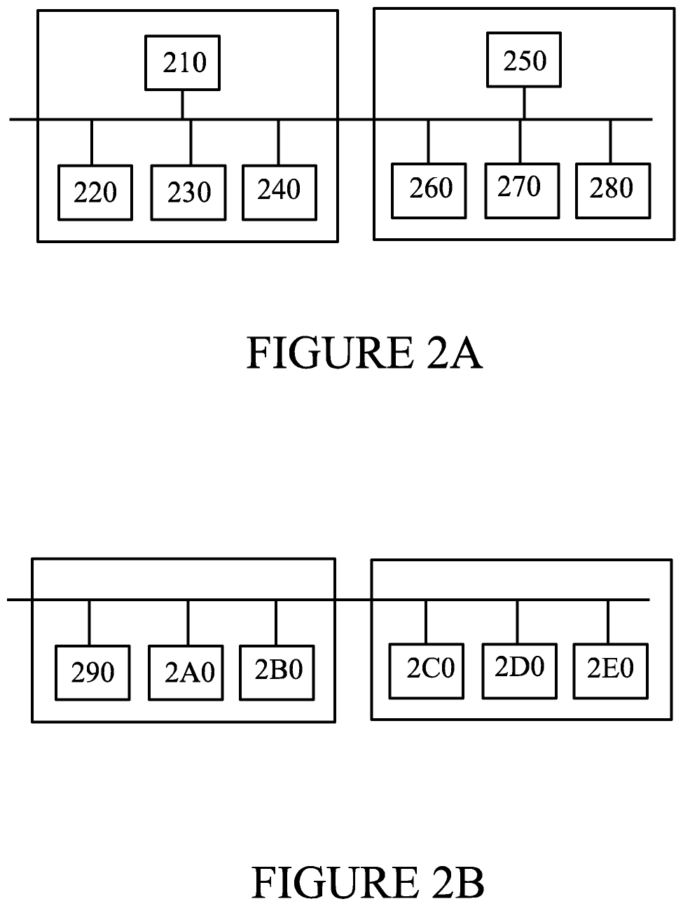

FIG. 2A illustrates an example service-based radio access network, RAN, SB-RAN, embodiment. This embodiment relates to the data synchronization between active and stand-by CU-CP node(s). Service-based architecture is a framework that is emerging in the 3GPP environment, where a service-based interface is utilized among network elements/functions. The embodiments of FIGS. 2A and 2B extend the scope of the herein disclosed proposed resiliency mechanisms toward the SB-RAN framework to maximize benefits. In a service-based RAN, the implementation of the data synchronization could be as described in the embodiments of FIG. 2A and/or 2B.

In the SB-RAN architecture, a CU-CP set and CU-CP sets can be deployed. Considering potential requirement on geo-redundancy, CU-CP sets may be separated spatially, meaning that they may not be implemented/deployed in the same location, rather, for example, different cloud environments can be used. A failure can impact an active CU-CP in a set, or a complete CU-CP set may fail. A CU-CP can comprise at least one CU-CP.

In the embodiment of FIG. 2A, an unstructured data storage function, RAN-UDSF or RAN data storage function, RAN-DSF 210, 250 is utilized to fetch UE contexts and synchronize this data across CU-CP sets such as set {220, 230, 240} or set {260, 270, 280}. The sets are exemplarily depicted in different geographical locations, for example, in different physical computation substrates such as servers or clouds. The synchronization may be triggered, for example, responsive to a number of involved UEs increases above a certain threshold, to an anomaly detection indicating a higher probability of a failure. A RAN-NRF, network repository function, may be utilized for discovering CU-CP sets across different locations. In detail, UE contexts may be copied from, for example, CU-CP 220 to UDSF 210, and from UDSF 210 to UDSF 250. Initially, CU-CP 220, which originates the UE contexts, may be the only active CU-CP in the sense that only it controls the DU involved.

FIG. 2B illustrates an example service-based radio access network, SB-RAN, embodiment. In this embodiment, UE contexts are stored in a distributed manner. The synchronization of UE contexts across CU-CP sets may be triggered by, for example, a number of involved UEs increasing above a predetermined threshold, or an anomaly detection indicating a higher probability of failure. CU-CP sets {290, 2A0, 2B0} and {2C0, 2D0, 2E0} are defined. The sets are exemplarily depicted in different geographical locations, for example, in different physical computation substrates such as servers or clouds. UE context data may be propagated within a set, such as from CU-CP 290 to CU-CPs 2A0 and 2B0, and to the other set of CU-CPs. Initially, CU-CP 290, which originates the UE contexts, may be the only active CU-CP in the sense that only it controls the DU involved.

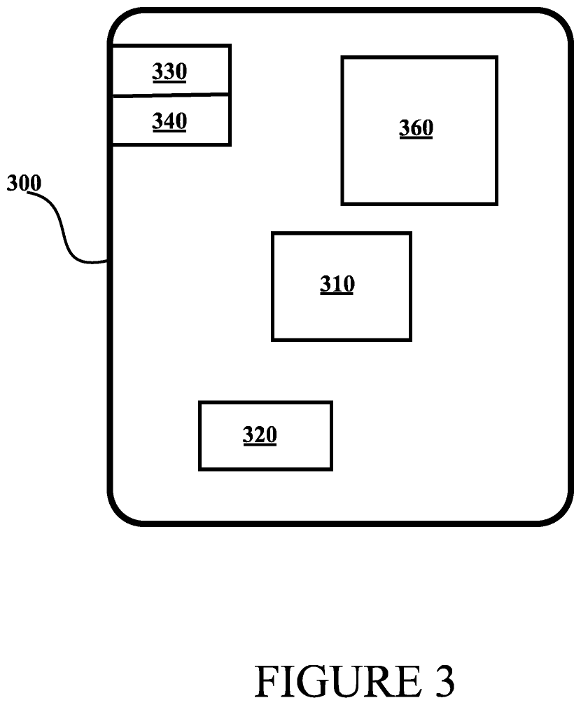

FIG. 3 illustrates an example apparatus capable of supporting at least some embodiments of the present invention. Illustrated is device 300, which may comprise, for example, a device such as a computer configured to act as a CU or DU, or another network node. Comprised in device 300 is processor 310, which may comprise, for example, a single- or multi-core processor wherein a single-core processor comprises one processing core and a multi-core processor comprises more than one processing core. Processor 310 may comprise, in general, a control device. Processor 310 may comprise more than one processor. Processor 310 may be a control device. A processing core may comprise, for example, a Cortex-A8 processing core manufactured by ARM Holdings or a Zen processing core designed by Advanced Micro Devices Corporation. Processor 310 may comprise at least one Qualcomm Snapdragon and/or Intel Atom processor. Processor 310 may comprise at least one application-specific integrated circuit, ASIC. Processor 310 may comprise at least one field-programmable gate array, FPGA. Processor 310 may be means for performing method steps in device 300, such as performing, setting up, synchronizing, switching, signalling, participating, maintaining and determining. Processor 310 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analogue and/or digital circuitry, and (b) combinations of hardware circuits and software, such as, as applicable: (i) a combination of analogue and/or digital hardware circuit(s) with software/firmware and (ii) any portions of hardware processor(s) with software (including digital signal processor(s)), software, and memory(ies) that work together to cause an apparatus, such as a server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with suitable communication protocols, such as those used in a radio-access and core network of a cellular communication network.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to configure network parameters.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. Device 300 may comprise a fingerprint sensor arranged to authenticate, at least in part, a user of device 300. In some embodiments, device 300 lacks at least one device described above.

Processor 310, memory 320, transmitter 330, receiver 340, and/or UI 360 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

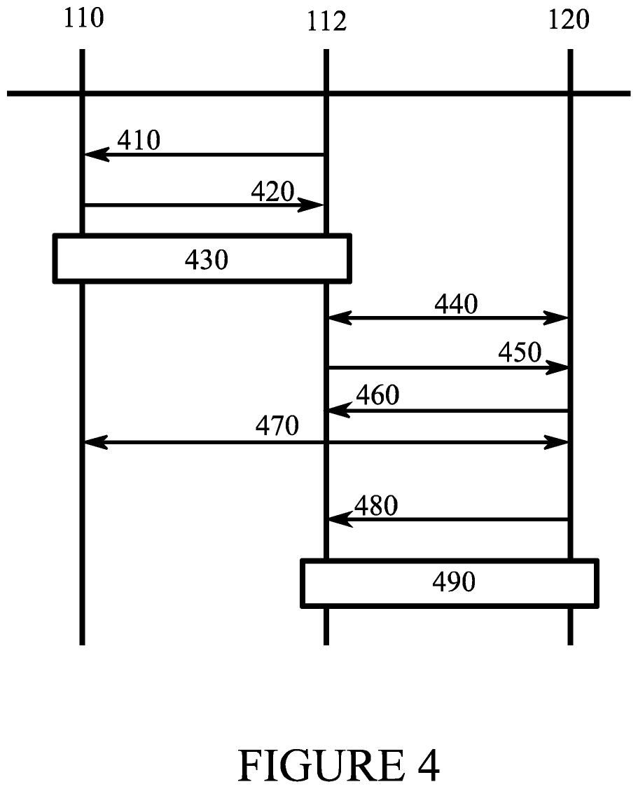

FIG. 4 illustrates signalling in accordance with at least some embodiments of the present invention. On the vertical axes are disposed, on the left, serving CU 110 of FIG. 1, in the centre, DU 112 and on the right, backup CU 120 of FIG. 1. In particular, the logical CU-CP nodes of the logical CU nodes 110, 120 are meant. Time advances from the top toward the bottom. The example method of FIG. 4 takes place in a 3GPP environment.

In phase 410, an F1 interface setup request is sent by DU 112 to CU 110. In response, CU-UP of CU 120 issues to DU 112 an F1 setup response, accepting the request of phase 410. The response of phase 420 comprises an address, for example an IP address, of backup CU 120 and an explicit or implicit request to establish an F1 connection with the backup CU CU-CP node into the inactive state. An active F1 interface is in existence between CU 110 and DU 112 in phase 430, which is to be understood as a continuing phase ending only after phase 470 has begun.

In phase 440, an SCTP association is setup between DU 112 and the CU-CP node of CU 120. The SCTP association is set up into the inactive state, wherefore DU 112 only has one active SCTP association, that being with the CU-CP node of CU 110.

In phase 450, DU 112 requests an F1 interface to be set up into the inactive state between itself and the CU-CP node of CU 120. A setup response is issued from the CU-CP of CU 120 in phase 460. Following phase 460, DU 112 has an active F1 interface with CU 110 and an F1 interface in the inactive state with CU 120.

Phase 470 represents synchronization of data between active CU 110 and backup CU 120. As discussed herein above, synchronizing this data, which may comprise UE contexts, serves to reduce delays in case the backup CU 120 needs to switchover to the active role, where it controls DU 112. The synchronization of phase 470 is a continuous process and continues for as long as the protocol connection(s), such as SCTP association and F1 interface, between DU 112 and CU 120 remain in their inactive states.

At some point, a core network node or a control entity or management entity, for example, may determine that the CU-CP of CU 110 has failed and consequently that switchover to CU 120 needs to be performed. CU 120 is informed of this and, responsive to this, CU 120 in phase 480 triggers the switchover, wherein CU 120 assumes control of DU 112, and the protocol connections(s) between DU 112 and CU 120 are converted from their inactive states to active states. In phase 490, an active F1 interface is in place between DU 112 and CU 120.

The following logical nodes may trigger establishment of an inactive SCTP connection and/or an interface. The CU-CP may trigger the setup of an inactive SCTP and NG interface connection towards the access and mobility management function, AMF. The CU-CP may provide the IP address of the backup CU-CP to setup an inactive E1 interface connection and the setup may be triggered by gNB-CU-UP. The CU-CP of either gNB at the terminating edges of Xn interface may trigger the setup of an inactive Xn connection. The backup CU-CP may trigger the setup of an inactive SCTP and Xn interface connection towards one or more base stations. A control entity, e.g., core network function or near-real time RIC, or management entity, e.g., OAM or non-real time RIC, may trigger the setup of an inactive SCTP and Xn interface connection towards one or more base stations.

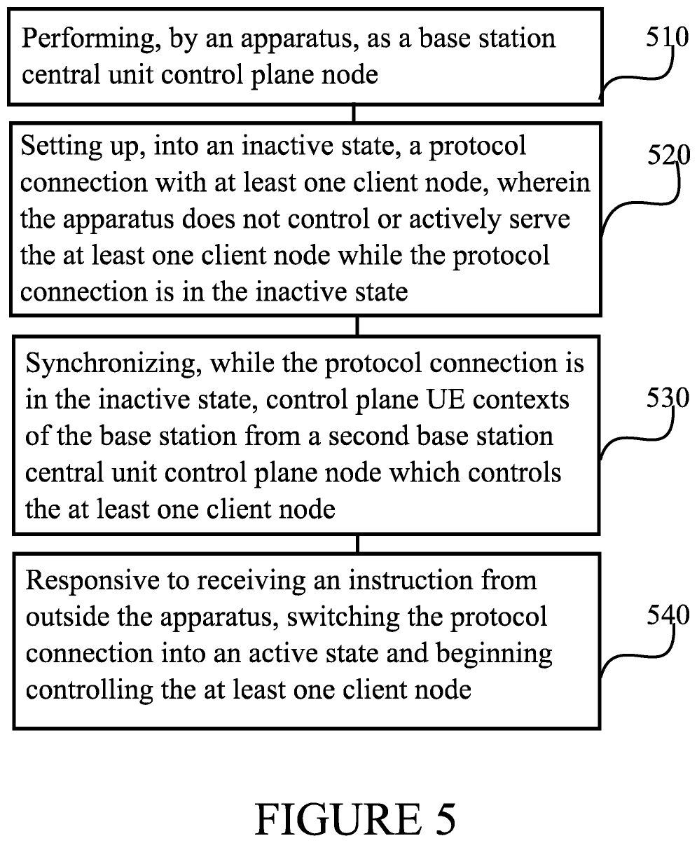

FIG. 5 is a flow graph of a method in accordance with at least some embodiments of the present invention. The phases of the illustrated method may be performed in a standby CU-CP node, for example.

Phase 510 comprises performing, by an apparatus, as a base station central unit control plane node. Phase 520 comprises setting up, into an inactive state, a protocol connection with at least one client node, wherein the apparatus does not control or actively serve the at least one client node while the protocol connection is in the inactive state. Phase 530 comprises synchronizing, while the protocol connection is in the inactive state, control plane user equipment contexts of the base station from a second base station central unit control plane node which controls the at least one client node. Phase 540 comprises, responsive to receiving an instruction from outside the apparatus, switching the protocol connection into an active state and beginning controlling the at least one client node. The at least one client node may comprise at least one base station distributed unit.

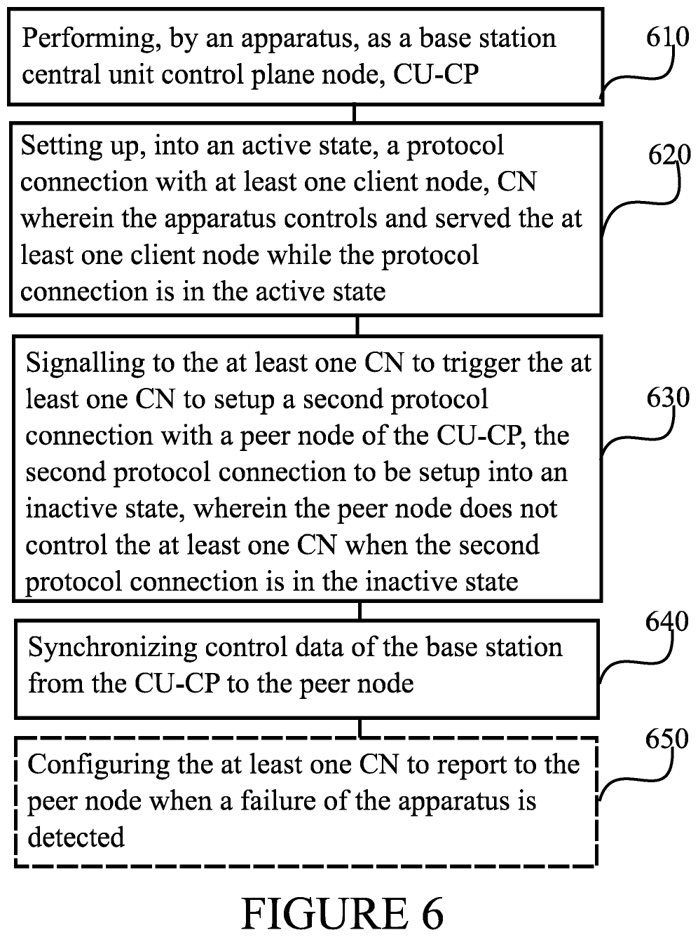

FIG. 6 is a flow graph of a method in accordance with at least some embodiments of the present invention. The phases of the illustrated method may be performed in an active CU-CP node, for example.

Phase 610 comprises performing, by an apparatus, as a base station central unit control plane node. Phase 620 comprises setting up, into an active state, a protocol connection with at least one client node, wherein the apparatus controls and serves the at least one client node while the respective protocol connection is in the active state. Phase 630 comprises signalling to the at least one client node to trigger the at least one client node to setup a second protocol connection with a peer node of the base station central unit control plane node, the second protocol connection to be setup into an inactive state, wherein the peer node does not control the at least one client node while the second protocol connection is in the inactive state. Phase 640 comprises synchronizing control data of the base station from the base station central unit control plane node to the peer node. Finally, optional phase 650 comprises configuring the at least one client node to report to the peer node when a failure of the apparatus is detected. An optional phase is absent in some embodiments. The peer node may be another CU, for example.

Technical benefits of the disclosed methods include detection of CU-CP failure using standard interfaces, increasing resiliency of CU-CP without requiring more than one active interface from a DU, providing a seamless switchover to a backup CU-CP and use of SB-RAN mechanisms to propagate data to be synchronized to backup CU-CPs. The fast switchover may enable call continuity during failover. Having a single active F1 interface at a time avoids fragmentation of resource coordination, since a DU is controlled by a single CU-CP.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in management of communication networks.

### Acronyms List

3GPP third generation partnership project
5G fifth generation
CU central unit
CU-CP base station central unit control plane (logical node)
CU-UP base station central unit user plane (logical node)
DU distributed unit
F1 interface between CU and DU
gNB base station in 5G systems
PDCP packet data convergence protocol
RAN-NRF network repository function
SCTP stream control transmission protocol
UE user equipment
Xn-C interface between CU nodes of base stations

1-41. (canceled)

42. An apparatus comprising at least one processing core, at least one memory including computer program code, the at least one memory and the computer program code being configured to, with the at least one processing core, cause the apparatus at least to:
perform as a base station central unit control plane node;
setup, into an inactive state, a protocol connection with at least one client node, wherein the apparatus does not control or actively serve the said client node while the protocol connection is in the inactive state;
synchronize, while the protocol connection is in the inactive state, at least one control plane user equipment context of the base station from a second base station central unit control plane node which controls the at least one client node, and
responsive to receiving an instruction from outside the apparatus, switch the protocol connection into an active state and begin controlling the at least one client node.

43. The apparatus according to claim 42, wherein the apparatus is configured to notify peer nodes of the apparatus that the apparatus has taken over as active base station central unit control plane node and begun controlling and serving the at least one client node.

44. The apparatus according to claim 42, wherein the protocol connection comprises at least one of an F1, E1, NG, Xn, X2, and E2 interface as specified by the third generation partnership project and/or ORAN forum.

45. The apparatus according to claim 42, wherein the protocol connection comprises a service-based interface, SBI, in a service-based radio access network architecture.

46. The apparatus according to claim 42, wherein the protocol connection comprises a stream control transmission protocol connection and an application protocol interface.

47. The apparatus according to claim 42, wherein the apparatus is further configured to monitor the second base station central unit control plane node for failures, and to report failure of the second base station central unit control plane node to a further network node.

48. The apparatus according to claim 42, wherein the at least one client node comprises a base station distributed unit, a base station central unit user plane node, a neighbouring base station node, an access and mobility management function, or a near-real-time radio access network intelligent controller.

49. The apparatus according to claim 42, further configured to at least one of: receive failure reports concerning the second base station central unit control plane node from the at least one client node, and ping the second base station central unit control plane node to verify that the second base station central unit control plane node has developed a failure.

50. The apparatus according to claim 42, wherein the apparatus is configured to perform the synchronizing via a service-based radio access network or via a radio access network data storage function.

51. An apparatus comprising at least one processing core, at least one memory including computer program code, the at least one memory and the computer program code being configured to, with the at least one processing core, cause the apparatus at least to:
perform as a base station central unit control plane node;
setup, into an active state, a protocol connection with at least one client node, wherein the apparatus controls and serves the at least one client node while the respective protocol connection is in the active state;
signal to the at least said one client node to trigger the at least one said client node to setup a respective second protocol connection with a peer node of the base station central unit control plane node by providing configuration information, the second protocol connection to be setup into an inactive state, wherein the peer node does not control the respective client node while the respective second protocol connection is in the inactive state, and
synchronize, control data of the base station from the base station central unit control plane node to the peer node.

52. The apparatus according to claim 51, further configured to configure the at least one client node to report to the peer node when a failure of the apparatus is detected.

53. The apparatus according to claim 51, wherein the control data of the base station comprises user equipment contexts of user equipments served by the base station central unit control plane node.

54. The apparatus according to claim 51, wherein each of the protocol connection and the second protocol connection comprises at least an F1, E1, NG, Xn, X2 and E2 interface as specified by the third generation partnership project or ORAN forum, or a service-based interface.

55. The apparatus according to claim 51, wherein the at least one client node comprises at least one of a base station distributed unit, a base station central unit user plane node, a neighbouring base station node, an Access and mobility management function and a near-real-time radio-access network intelligent controller.

56. An apparatus comprising at least one processing core, at least one memory including computer program code, the at least one memory and the computer program code being configured to, with the at least one processing core, cause the apparatus at least to:
perform as a client node;
participate in setting up, into an active state, a first protocol connection with a first base station central unit control plane node, wherein the first base station central unit control plane node controls the apparatus while the first protocol connection is in the active state;
participate in setting up, into an inactive state, a second protocol connection with a second base station central unit control plane node, wherein the second base station central unit control plane node does not control the apparatus while the second protocol connection is in the inactive state, and maintain the second protocol connection in the inactive state while the first base station central unit control plane node controls the apparatus over the first protocol connection.

57. The apparatus according to claim 56, wherein the apparatus is configured to, responsive to a signal from the second base station central unit control plane node, participate in switching the second protocol connection into the active mode, where the second base station central unit control plane node controls the apparatus.

58. The apparatus according to claim 56, wherein the at least one client node comprises at least one of a base station distributed unit, a base station central unit user plane node, a neighbouring base station node, an Access and mobility management function and a near-real-time radio-access network intelligent controller.

59. An apparatus comprising at least one processing core, at least one memory including computer program code, the at least one memory and the computer program code being configured to, with the at least one processing core, cause the apparatus at least to:
determine that a first base station central unit control plane node, tasked with controlling a base station distributed unit, has developed a failure, and
responsive to the determination of the failure, signal to a second base station central unit control plane node, which is a stand-by to the first base station central unit control plane node, to trigger the a second base station central unit control plane node to switch its protocol connection with at least the one client node from an inactive state to an active state, to enable the second base station central unit control plane node to control and serve the at least one client node.

60. The apparatus according to claim 59, wherein the determination that the first base station central unit control plane node has developed the failure is based on at least one of the following:
a signal from the second base station central unit control plane node indicating the first base station central unit control plane node has developed the failure;
traffic statistics of the first base station central unit control plane node no longer matching acceptable parameters, and
a machine learning classifier decision based on traffic parameters of the first base station central unit control plane node.
